(19) United States
(12) Patent Application Publication
(10) Pub. No.: US 2025/0087038 A1
(43) Pub. Date: Mar. 13, 2025

(54) A SYSTEM FOR CONTROLLING A PARKING SPACE BARRIER AND A METHOD FOR CONTROLLING A PARKING SPACE BARRIER

(71) Applicant: BLOKADO SP. Z O. O., Warszawa (PL)

(72) Inventors: Artur FOKSA, Warszawa (PL); Pawel WNUK, Józefoslaw (PL); Michal Syfert, Warszawa (PL)

(73) Assignee: BLOKADO SP. Z O. O., Warszawa (PL)

(21) Appl. No.: 18/720,465

(22) PCT Filed: Dec. 15, 2022
(86) PCT No.: PCT/EP2022/086185

§ 371 Date: Jun. 14, 2024

(30) Foreign Application Priority Data
Dec. 16, 2021 (EP) 21461636.9

(51) Int. Cl. G07C 9/10; G07B 15/04; G08G 1/01; G08G 1/14; H04W 4/44; H04W 4/80; H04W 12/084; H04W 12/102; H04W 12/63

(52) U.S. Cl. CPC G07C 9/10; G07B 15/04; G08G 1/01; G08G 1/149; H04W 4/44; H04W 4/80; H04W 12/084; H04W 12/102; H04W 12/63

(57) ABSTRACT

A system for controlling a parking space barrier, which includes:
at least one parking space barrier, with a system for changing the position of the barrier in order to control the possibility for the parking space to be entered by a vehicle, a system for detecting the presence of a vehicle in the parking space, a system for communicating the barrier with a driver's terminal and a system for communicating the barrier with a base station,
a base station, which has a system for communicating the station with the barrier and a system for communicating the station with a server,
a server, configured and intended to manage one or more parking space barriers, having access to a database which stores at least the data about drivers, the company or organisation and the barriers, as well as information about the authorisation of a given driver to change the position of a given barrier, and further provided with a system for communicating the server with a driver's application, a system for communicating the server with an administration application and a system for communicating the server with the base station,
a driver's application, installed on a driver's terminal, which is preferably a smartphone, a tablet or a computer, enabling communication with the barrier and with the server,
an administration application, configured and intended to operate the parking barriers and manage the drivers' authorisation to change the position of the parking barriers, preferably operating on an administrator's terminal, especially a computer, a tablet or a smartphone, using a www application.

### TECHNICAL FIELD

The object of the invention is a solution related to an intelligent parking bollard along with a method for controlling such a bollard, forming an intelligent paid parking system.

### BACKGROUND ART

From prior art, there are several known solutions related to paid parking systems based on intelligent parking bollards.

The international patent application published as WO2021086299A1 describes a system for monitoring and controlling public paid parking spaces. The solution comprises an operating terminal, a telephone application, a server connecting to the terminal, a method for locking parking spaces, and it can additionally comprise a module utilised to charge electric cars. Unlike the present invention, this system focuses on applying to autonomous cars, and their identification the system uses the vehicle registration number, furthermore, this solution requires an additional stationary terminal used to operate the bollards.

Polish patent application no. P.424117 describes an intelligent parking bollard, provided with vision and sensory modules, allowing for identification of the vehicle, monitoring the duration of parking, charging and collecting fees, issuing fines in the event of an unpaid fee, as well as sending and receiving data from a communications centre. The system is intended to manage parking spaces, primarily in urban agglomerations. Unlike the present invention, the bollard identifies the vehicle and not the user's smartphone, also not providing for a number of scenarios, such as sharing, managing a parking lot, company parking, etc.

The commercially available Parklio solution is a remotely controlled parking barrier, which can be controlled by an application on a smartphone. The barrier connects with the telephone by means of Bluetooth; it enables integration with parking systems, renting parking spaces by sending a virtual key to other users, and it enables the user to find the parking space. Differences with respect to the present solution exist in terms of network operation, and more precisely, Parklio communication proceeds directly between the barrier and the telephone, without the use of a server, an administration part and a base station of the barriers, which renders it impossible to remotely open the barriers and safely share the parking spaces with other users. Therefore, in the Parklio solution, it is not possible to implement various scenarios of use and billings provided by the present invention, e.g. remote opening of barriers, sharing of a parking space, controlling multiple barriers including controlling various types of barriers, e.g. a bollard in a specific parking space and a boom gate at the entrance to a parking lot in which there are numerous parking spaces.

From prior art, there are also known patent publications such as EP2299409B1, EP2184717B1 or EP315848B1; they describe a number of network solutions related to systems for managing a parking lot, detecting vehicles with a detector of unoccupied spaces, while none of them comprise a parking barrier or a system for automatic control of such a barrier.

### SUMMARY OF INVENTION

A system for controlling a parking space barrier, which comprises:
at least one parking space barrier, comprising a system for changing the position of the barrier in order to control the possibility for the parking space to be entered by a vehicle, a system for detecting the presence of a vehicle in the parking space, a system for communicating the barrier with a driver's terminal and a system for communicating the barrier with a base station,
a base station, which comprises a system for communicating the station with the barrier and a system for communicating the station with a server,
a server, configured and intended to manage one or more parking space barriers, having access to a database which stores at least the data about drivers, the company or organisation and the barriers, as well as information about the authorisation of a given driver to change the position of a given barrier, and further provided with a system for communicating the server with a driver's application, a system for communicating the server with an administration application and a system for communicating the server with the base station,
a driver's application, installed on a driver's terminal, which is preferably a smartphone, a tablet or a computer, enabling communication with the barrier and with the server,
an administration application, configured and intended to operate the parking barriers and manage the drivers' authorisation to change the position of the parking barriers, preferably operating on an administrator's terminal, especially a computer, a tablet or a smartphone, using a www application.

Preferably, the barrier is a bollard, a boom gate, a spike strip, a barricade or a gate.

Preferably, the system for detecting a vehicle in the parking space comprises a laser, ultrasound, radar or optical sensor.

Preferably, the barrier system for communicating with the driver's terminal is configured for wireless communication, especially using a Bluetooth protocol, near-field communication (NFC) or a wireless computer network (WiFi).

Preferably, the barrier system for communication with the base station is configured to communicate by means of a wireless communication standard, in particular low-power wide-area communication (LoRa), Bluetooth, ZigBee, Z-wave, LTE-M, NB-IoT or WiFi.

Preferably, the server is software capable of working on a traditional server, on a virtual host in a cloud, or as a dispersed service utilising a PAAS cloud platform (platform as a service).

Preferably, the administration application is placed on a www server, and the administrator's terminal downloads the application after entering a proper www page for the duration of using this page.

Preferably, the barrier additionally has a system for detecting an attempt at forcing the barrier open, preferably configured to send information about such an event to the base station and/or to the driver's terminal.

Preferably, it comprises a system for detecting an attempt at forcing the barrier open, which system communicates with the server, the barrier's owner or the administrator, informing them about such an attempt.

A method for controlling a parking space barrier in the system according to any of the abovementioned features, which method comprises the following steps:
assigning each barrier a secret string and saving this string in the barrier and on the server,
encrypting a token by the server using said secret string as an encrypting key, or calculating, by the server, the hash function setpoint for a string comprising the token and said secret string,
encrypting the same token by the barrier using said secret string as an encrypting key, or calculating, by the barrier, the hash function setpoint for a string comprising the token and said secret string,
checking by the barrier whether the result of the encryption performed by the barrier and the encryption performed by the server is identical, by comparing tokens encrypted by the server and encrypted by the barrier, or by comparing the hash function setpoint calculated by the server and calculated by the barrier for the same secret and the same token, and if so,
changing the position of the barrier in order to enable the entry of a vehicle into the parking space.

Preferably, the token is a one-time token, said secret string is unique and different for each barrier, while the method comprises the following steps:
sending a request to open the parking space barrier from the driver's terminal to said barrier,
sending a one-time token from the parking space barrier to the driver's terminal,
handing over this token by the driver's terminal to the server for its encryption,
checking, by the server in the database, the authorisation of a given driver to change the position of a given barrier, and in the case of confirming this authorisation;
encrypting this token by the server using said secret string as an encrypting key, or calculating, by the server, the hash function setpoint for a string comprising the token and said secret string,
returning this encrypted token or the calculated hash function setpoint by the server to the driver's terminal,
handing over this encrypted token or the calculated hash function setpoint by the driver's terminal to the parking space barrier,
encrypting the original form of the token by the parking space barrier, using said secret string as an encrypting key, or calculating, by the barrier, the hash function setpoint for a string comprising the token and said secret string,
comparing, by the parking space barrier, the form of the token encrypted by the barrier with the encrypted form of the token received from the server via the driver's terminal, or the hash function setpoint calculated by the server and calculated by the barrier for the same secret and the same token,
in the event of compliance of these forms or compliance of the hash function setpoints-changing the position of the barrier in order to enable the entry of a vehicle into the parking space.

Preferably, it additionally comprises the following steps:
sending a request to open the parking space barrier by the server to the base station,
sending a request to open the parking space barrier by the base station to the parking space barrier,
changing the position of the barrier in order to enable the entry of a vehicle into the parking space.

Preferably, in the database which stores at least the data about drivers and the barriers as well as information about the authorisation of a given driver to change the position of a given barrier, said authorisation results from one or more of the following events: granting authorisation by another driver by means of the driver's application, in particular permanently, for a definite time or once; granting authorisation by the administration application, in particular permanently, for a definite time or once; the driver's paying for the use of a given parking space; granting authorisation by the driver's application or by the administration application, or by means of a supertoken, for an emergency vehicle, for example a vehicle of rescue services, by a company or organisation which has authorisation for a group of sites or barriers.

Preferably, it comprises the additional parking validation step, involving the confirmation of the physical presence of the driver in a specified location, for example in a shop or in a service company, by photographing a QR code placed in this location, or by receiving a signal from a beacon placed in this location by the driver's terminal.

### DESCRIPTION OF THE DRAWINGS

The invention will now be presented in more detail in a preferable embodiment, with reference to the attached drawing, in which:

FIG. 1 Shows the structure of the barrier system and the connection of communication protocols.

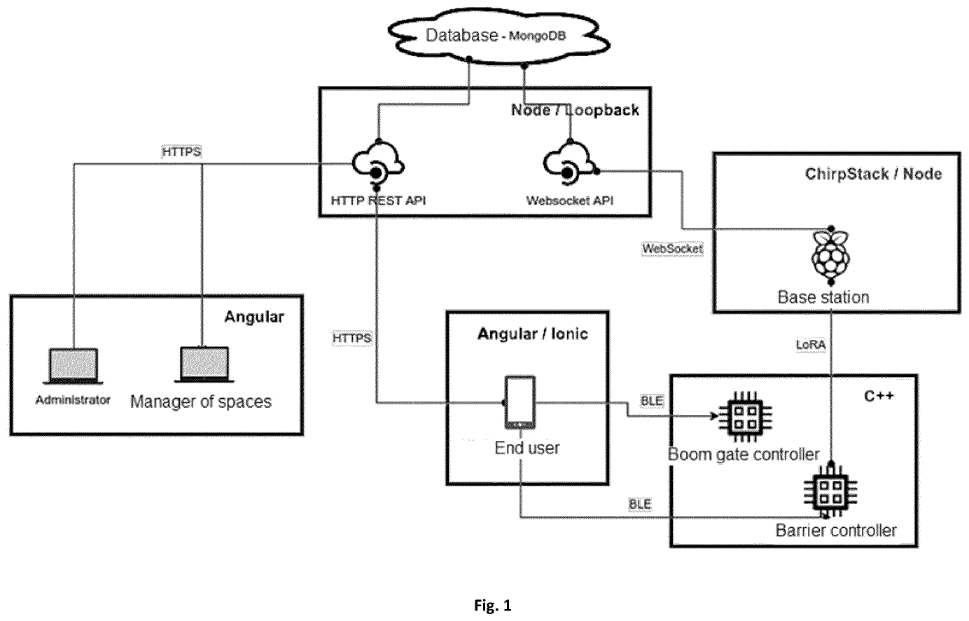

FIG. 2 Shows a block diagram of a scenario of ending the parking by the end user.

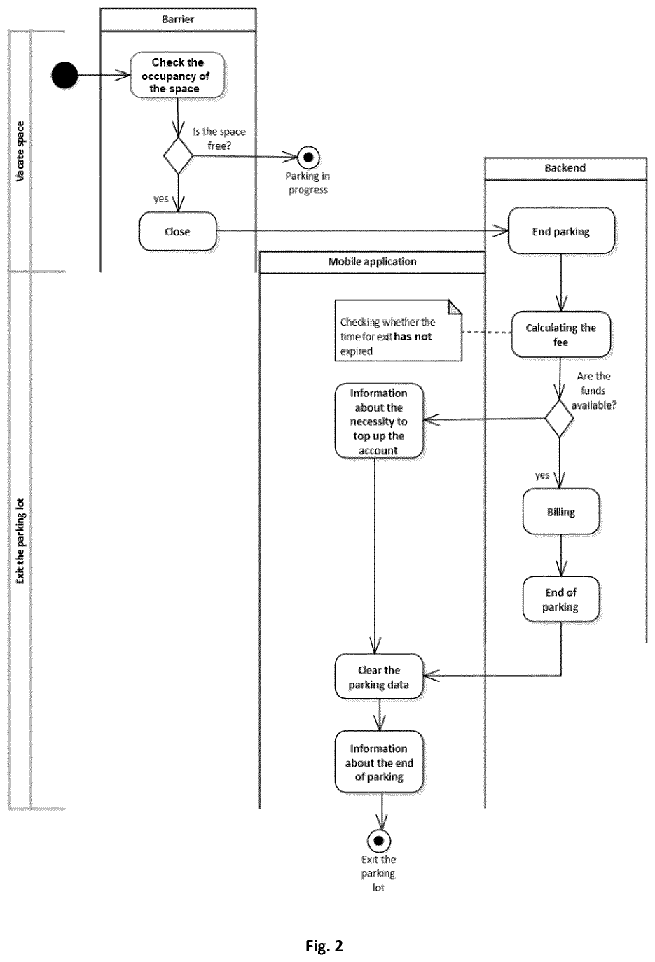

FIG. 3 Shows a block diagram of a scenario of opening the barrier by the end user.

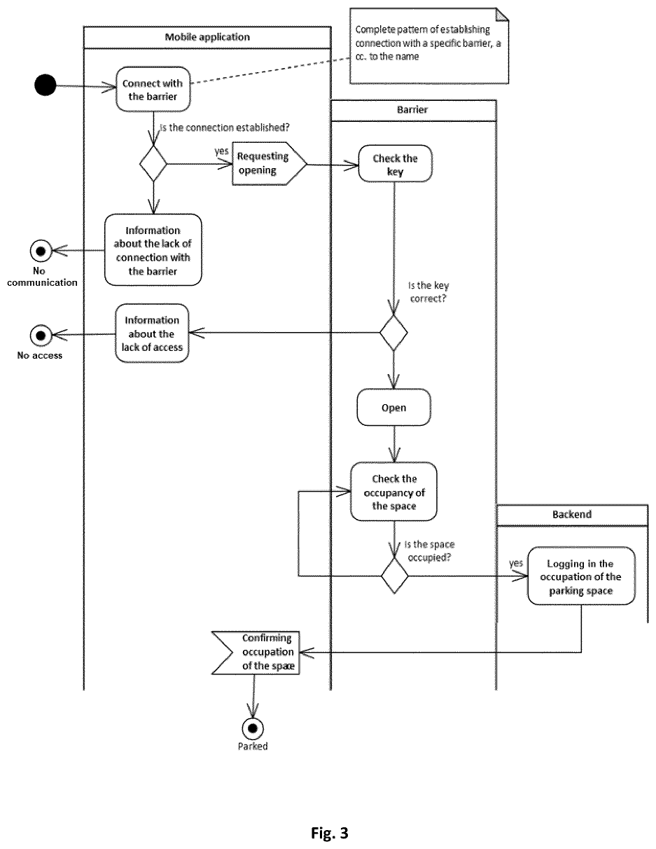

FIG. 4 Shows a block diagram of a scenario of reserving a parking space.

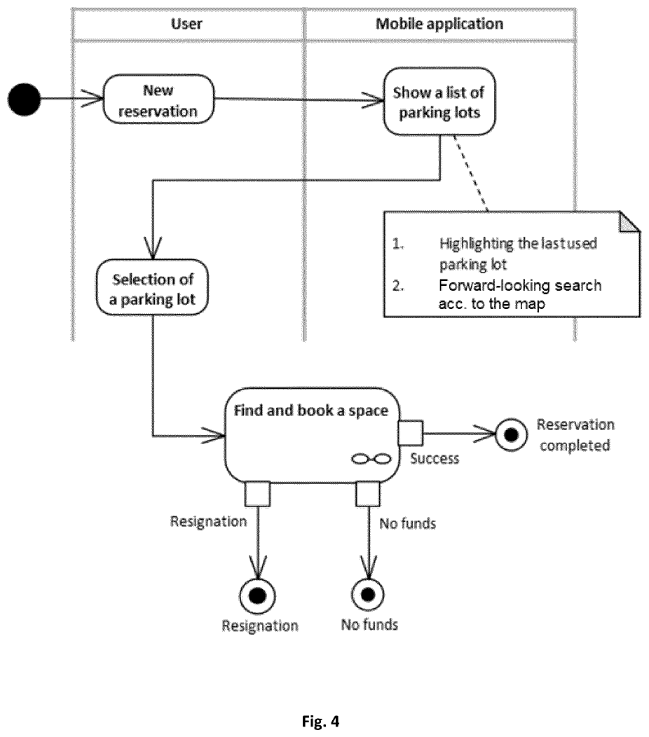

FIG. 5 Shows a block diagram of a scenario of exiting the parking lot.

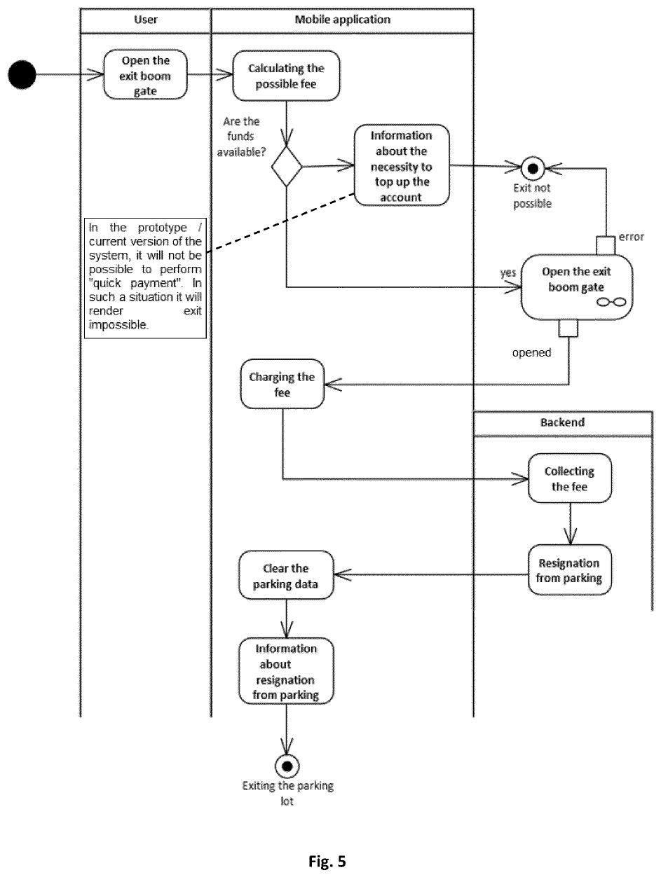

### PREFERRED EMBODIMENT OF THE INVENTION

In a preferred embodiment, the solution comprises a parking bollard comprising a control system, which enables detection of a vehicle, including detection of occupying a parking space and vacating it, without distinguishing between vehicles. A car is only identified by the user's application, not via a physical marker or identification, due to which the opening of the parking bollard is controlled by detecting the distance of the smartphone with the authorisation, not the vehicle itself. The parking bollard communicates with the client's smartphone, which enables its automatic opening when approached by a client having the authorisation to park. In addition, the system comprises a base station serving to communicate the bollards by a LoRA-type low-power wide-area wireless communication protocol with the Internet, and more precisely with a server in a cloud, where the server is used to store the data of the drivers, companies or organisations, as well as data related to managing a group of parking spaces, their reservation, renting or handing over authorisation by the drivers, companies or organisations. Specifically, the base station is an intermediary in communication, communicating with a bollard (a plurality of bollards) via LoRa, and with the Internet via GSM/LTE/WiFi/Ethernet, or in another standard manner.

The system consists of a series of modules, communicating using various network protocols:

### 1. Database-MongoDB

According to an embodiment, the structure of the database is generated by ORM tools (object-relational mapping). It allows for adding, downloading and converting various types of data, and it enables communication with the base station. It is also possible to use any other relational or nonrelational database.

The database stores data about the drivers and the barriers as well as information about the authorisation of a given driver to change the position of a given barrier. In the database, a driver is identified with a specific user of the system, and they are identified by a unique username in the system. Said authorisation results from one or more of the following events:
granting authorisation by another driver by means of the driver's application, in particular permanently, for a definite time or once;
granting authorisation by the administration application, in particular permanently, for a definite time or once;
the driver's payment for the use of a given parking space;
granting authorisation by a company or organisation which has authorisation for a group of spaces or barriers;
granting authorisation by the driver's application or by the administration application for an emergency vehicle, for example a vehicle of rescue services, for example as a result of a telephone call of a driver of such a vehicle to the system administrator;
the possession of a supertoken by a user, enabling the user's access to any barrier.

Unlike the standard cycle of opening a barrier, where an individual encrypted token established for each barrier is confirmed, a second type of identical tokens present in each barrier is used, allowing the user to unlock any barrier;
unlocking a parking space made accessible by the manager of, e.g. a service facility, followed by validation of using a given service facility via a beacon or a QR code placed in the given service facility.

In a normal cycle of opening a barrier, there is a secret string, established for each barrier individually and unique (i.e. different for each barrier). This string is used by the server as a key for encrypting a one-time token, and by the barrier to encrypt the same token, and to check whether the result of local encryption (performed by the barrier) and the one received from the server is identical. If it is identical—the same data are encrypted with the same key, which confirms that the barrier and the server share the same secret (key). In the case of a supertoken, we are dealing with a second secret string (second key), embedded in all barriers and identical in all of them. The followed procedure is analogical as in the case of the procedure for normal opening, except the encryption uses this second key, shared between all barriers, and therefore everyone who knows it can open any barrier.

The access to this supertoken (supersecret) is granted analogically to the access to the individual bollards-a given user may simply use it or not (then the authorisation occurs online), or the user may acquire a copy of the second secret key on their own terminal, and then the authorisation occurs offline.

### 2. The Server

Activated in a cloud, a server with a REST architecture (Representational State Transfer); it allows for using the resources and data of a different system as an intermediary in the exchange of data via an API interface (application programming interface) for three applications:
The end user's (driver's) application—native or PWA
The administration application—a webpage
The application of the manager of parking spaces-a webpage

For example, the used server is based on the Loopback 4 framework; however, it is possible to use a server based on another framework. A JSON web token is used to authenticate the users. In addition, the server shares an endpoint in a websocket protocol—used by the base stations. The endpoint software is made in NodeJS.

The server is capable of communicating with at least one portable device, with at least two PCs and at least one base station, this communication working both ways. Communication with the PC and with the end user proceeds by means of an HTTPS protocol. Communication with the base station proceeds by means of a websocket.

### 3. End User Software (Driver's Application)

It is a hybrid application, constructed using IONIC/Angular frameworks. Ultimately compiled to the form of a PWA application, a native application of Android and a native application of iOS; the contents of the page can be downloaded, which enables using the page in the offline mode. Due to the limitations of access to the device for the PWA application, the operating principle of the application is slightly different in the case of a Bluetooth connection with the actions of native applications. The application can operate on any smartphone, tablet and, in the PWA version, on a PC.

The application allows the owner of parking spaces for:
making a parking space available for other visitors according to rules specified by the owner
prior reservation of spaces
managing a user's account, e.g. registering an account, reading the payment history, the status of the account, managing payment channels
opening a boom gate or a barrier in order to occupy the space
monitor the duration of parking

The application can also be used by a driver not having a parking space, with the option of:
renting a space

The application is not intended solely for the owner of the spaces. It can also be used by a driver not having a space-they can rent them. The application does not charge fees—the fees are charged by the server.

### 4. Administrator's Software (Administration Application)

Prepared using Angular. It lacks a fully responsive version, adapted to mobile telephones. The application is operated by the Apache www server. By means of the software, the administrator sees a series of barrier statuses. The application allows for granting authorisation, establishing prices for various users, and remotely opening the barriers, e.g. on demand of emergency vehicles. This allows for implementing several parking scenarios in a single parking lot. Alternatively, the administrator has the ability to control a boom gate blocking a group of parking spaces for groups or individual users. The administrator's application and the driver's application can also be connected and operate on the same hardware, e.g. a smartphone, or they can be completely separate applications, operating on separate hardware. In a typical embodiment, the administration application is installed on a www server, and it is downloaded on the administrator's terminal after entering a proper www page, for the duration of using this page.

### 5. Parking Lot Manager Software

Prepared using Angular. It lacks a fully responsive version, adapted to mobile telephones. The version of the program (full administration interface/managing the parking lot) is selected at the moment of authorisation of the user. The application is operated by the Apache www server.

### 6. Base Station Software

The base station is based on the ChirpStack system, with which a program written in NodeJS communicates locally using an MQTT protocol. On the other hand, communication with the REST server proceeds using a WebSocket protocol. In addition, the base station comprises a router, using which it communicates with the blocking bollards using a LoRA wireless network.

### 7. Controller Software

The controller software is written in the C++ language. The controller program exists in two versions—the one intended for the barrier implements communication both via BluetoothLE (BLE), WiFi or NFC (with the user's application), as well as via wireless standards, such as WiFi, LoRA, ZigBee, Z-wave, LTE-M, NB-IoT and wired LAN networks, and in particular via Ethernet (with the base station).

### 8. Parking Space Barrier

The barrier can be bollards, boom gates, spike strips, gates or other similar methods for mechanically stopping a vehicle against unauthorised entry. They can be powered by batteries, accumulators or in a wired manner. Said barriers can communicate exclusively with the end user by means of BluetoothLE, and with the base station via LoRa, Bluetooth, BluetoothLE, ZigBee, Z-wave, LTE-M, NB-IoT or WiFi. It is also possible for the barrier to communicate with the base station by means of wired communication, e.g. by means of Ethernet. In addition, the barriers are provided with mechanisms allowing for automatic detection of an approaching vehicle and automatic marking of the end of parking when receiving information by a vehicle presence sensor, which can be, e.g. a laser, ultrasound or optical sensor. The barrier can also have a system for detecting an attempt to force the barrier open, which system in the case of such an attempt communicates with the base station and/or with the driver's terminal, and optionally via them with the administration application (administrator), the owner of the parking space or the server, informing them about such an attempt.

Control of the described parking space barrier proceeds according to the following steps.
a user who wants to unlock the barrier sends a request to open the parking space barrier from the driver's terminal, for example a telephone application.
the parking space barrier sends a one-time token to the driver's terminal,
the driver's terminal hands over the token to the server for its encryption,
the server checks the user's authorisation for a given space (whether the space has been purchased, whether the user has authorisation for it, whether access has been provided to the user, etc.),
the server encrypts the token, and subsequently returns the token to the user's smartphone,
the telephone hands over the encrypted token to the parking space barrier,
the parking space barrier encrypts the original form of the token,
the original form of the token is compared to the token received by the driver's terminal,
in the event of compliance of tokens, the parking space barrier is opened.

As mentioned above, the user can receive and grant authorisation to other users by the function of providing access, sharing, granting authorisation permanently and/or reservation of the parking space.

Alternatively, the parking space barrier can be controlled in the following manner
sending a request to open the parking space barrier by the server to the base station
sending a request to open the parking space barrier by the base station to the parking space barrier
opening the parking space barrier

Another alternative method for controlling the parking space barrier for communication without the use of a server comprises the following steps
sharing the barrier secret with the driver's terminal by the server for the duration of this driver's access of authorisation for the barrier
sending a request to open the parking space barrier from the driver's terminal to said barrier
generating a one-time token by the parking space barrier
sending the one-time token to the driver's terminal by the barrier
encrypting the token by the driver's terminal using a key created from the secret of the barrier
handing over the encrypted token to the parking space barrier by the parking space barrier
encrypting the original form of the token by the parking space barrier, using the key created from the secret of the barrier
comparing, by the parking space barrier, the encrypted original form of the token with the encrypted token received from the driver's terminal
in the case of compliance of both tokens, unlocking the barrier.

Alternatively, the token and the secret can also be connected to each other (concatenation of the token and the secret), transforming the produced resulting series of bytes by the selected cryptographic hash function—in particular: calculate the value of the selected hash function for a series of bytes in the form of the concatenated token and secret. The hashes produced in the server/driver's terminal and in the application can be compared. Then a hash transmission can be put wherever the transmission of the encrypted token occurs. In both cases, functionality and the level of safety are the same.

1-14. (canceled)

15. A system for controlling a parking space barrier, which comprises:
at least one parking space barrier, comprising a system for changing the position of the barrier in order to control the possibility for the parking space to be entered by a vehicle, a system for detecting the presence of a vehicle in the parking space, a system for communicating the barrier with a driver's terminal, a system for communicating the barrier with a base station and a computing device,
the base station, which comprises a system for communicating the base station with the barrier and a system for communicating the base station with a server,
the server, configured and intended to manage one or more parking space barriers, having access to a database which stores at least the data about drivers, the company or organisation and the barriers, as well as information about the authorisation of a given driver to change the position of a given barrier, and further provided with a system for communicating the server with a driver's application, a system for communicating the server with an administration application and a system for communicating the server with the base station,
a driver's application, installed on a driver's terminal, which is preferably a smartphone, a tablet or a computer, enabling communication with the barrier and with the server,
an administration application, configured and intended to operate the parking barriers and manage the drivers' authorisation to change the position of the parking barriers, preferably operating on an administrator's terminal, especially a computer, a tablet or a smartphone, using a www application,
and wherein the system is configured to perform the following steps:
assigning each barrier provided with a computing device a secret string and saving this string in the barrier and on the server,
on the user's request to change the position of the barrier, sending a token from the barrier to the server, by means of the driver's terminal,
checking, by the server in the database, the authorisation to change the position of the given barrier, and in the case of confirming this authorization encrypting the token by the server using said secret string as an encrypting key, or calculating, by the server, a hash function setpoint for a series of symbols comprising the token and said secret string,
encrypting the same token by the barrier using said secret string as an encrypting key, or calculating, by the barrier, the hash function setpoint for a string comprising the token and said secret string,
providing the barrier with the token encrypted or the calculated hash function setpoint by the server, preferably by means of the driver's terminal,
checking by the barrier whether the result of the encryption performed by the barrier and the encryption performed by the server is identical, by comparing tokens encrypted by the server and encrypted by the barrier, or by comparing the hash function setpoint calculated by the server and calculated by the barrier for the same secret and the same token, and if so,
changing the position of the barrier in order to enable the entry of a vehicle into the parking space.

16. The system according to claim 15, wherein the barrier is a bollard, a boom gate, a spike strip, a barricade or a gate.

17. The system according to claim 15, wherein the system for detecting a vehicle in the parking space comprises a laser, ultrasound, radar or optical sensor.

18. The system according to claim 15, wherein the barrier system for communicating with the driver's terminal is configured for wireless communication, especially using a Bluetooth protocol, near-field communication (NFC) or a wireless computer network (WiFi).

19. The system according to claim 15, wherein the barrier system for communication with the base station is configured to communicate by means of a wireless communication standard, in particular low-power wide-area communication (LoRa), Bluetooth, ZigBee, Z-wave, LTE-M, NB-IoT or WiFi.

20. The system according to claim 15, wherein the server is software capable of working on a traditional server, on a virtual host in a cloud, or as a dispersed service utilising a PAAS cloud platform (Platform As A Service).

21. The system according to claim 15, wherein the administration application is placed on a www server, and the administrator's terminal is configured to download the application after entering a correct www page for the duration of using this page.

22. The system according to claim 15, wherein the barrier additionally has a system for detecting an attempt at forcing the barrier open, preferably configured to send information about such an event to the base station and/or to the driver's terminal.

23. The system according to claim 15, wherein it comprises a system for detecting an attempt at forcing the barrier open, which system is configured to communicate with the server, the barrier's owner or the administrator, informing them about such an attempt.

24. A method for controlling a parking space barrier in the system according to claim 15, which method comprises the following steps:
assigning each barrier provided with a computing device a secret string and saving this string in the barrier and on the server,
on the user's request to change the position of the barrier, sending a token from the barrier to the server, by means of the driver's terminal,
checking, by the server in the database, the authorisation to change the position of the given barrier, and in the case of confirming this authorization encrypting the token by the server using said secret string as an encrypting key, or calculating, by the server, a hash function setpoint for a series of symbols comprising the token and said secret string,
encrypting the same token by the barrier using said secret string as an encrypting key, or calculating, by the barrier, the hash function setpoint for a string comprising the token and said secret string,
providing the barrier with the token encrypted or the calculated hash function setpoint by the server, preferably by means of the driver's terminal,
checking by the barrier whether the result of the encryption performed by the barrier and the encryption performed by the server is identical, by comparing tokens encrypted by the server and encrypted by the barrier, or by comparing the hash function setpoint calculated by the server and calculated by the barrier for the same secret and the same token, and if so,
changing the position of the barrier in order to enable the entry of a vehicle into the parking space.

25. The method according to claim 24, wherein the token is a one-time token, said secret string is unique and different for each barrier, while the method comprises the following steps:
sending a request to open the parking space barrier from the driver's terminal to said barrier,
sending a one-time token from the parking space barrier to the driver's terminal,
handing over this token by the driver's terminal to the server for its encryption,
checking, by the server in the database, the authorisation of a given driver to change the position of a given barrier, and in the case of confirming this authorisation;
encrypting this token by the server using said secret string as an encrypting key, or calculating, by the server, the hash function setpoint for a string comprising the token and said secret string,
returning this encrypted token or the calculated hash function setpoint by the server to the driver's terminal,
handing over this encrypted token or the calculated hash function setpoint by the driver's terminal to the parking space barrier,
encrypting the original form of the token by the parking space barrier, using said secret string as an encrypting key, or calculating, by the barrier, the hash function setpoint for a string comprising the token and said secret string,
comparing, by the parking space barrier, the form of the token encrypted by the barrier with the encrypted form of the token received from the server via the driver's terminal, or the hash function setpoint calculated by the server and calculated by the barrier for the same secret and the same token,
in the event of compliance of these forms or compliance of the hash function setpoints-changing the position of the barrier in order to enable the entry of a vehicle into the parking space.

26. The method according to claim 24, wherein it additionally comprises the following steps:
sending a request to open the parking space barrier by the server to the base station,
sending a request to open the parking space barrier by the base station to the parking space barrier,
changing the position of the barrier in order to enable the entry of a vehicle into the parking space.

27. The method according to claim 24, wherein, in the database which stores at least the data about drivers and the barriers as well as information about the authorisation of a given driver to change the position of a given barrier, said authorisation results from one or more of the following events: granting authorisation by another driver by means of the driver's application, in particular permanently, for a definite time or once; granting authorisation by the administration application, in particular permanently, for a definite time or once; the driver's paying for the use of a given parking space; granting authorisation by the driver's application or by the administration application, or by means of a supertoken, for an emergency vehicle, for example a vehicle of rescue services, by a company or organisation which has authorisation for a group of sites or barriers.

28. The method according to claim 24, wherein it additionally comprises the parking validation step, involving the confirmation of the physical presence of the driver in a specified location, for example in a shop or in a service company, by photographing a QR code placed in this location, or by receiving a signal from a beacon placed in this location by the driver's terminal.
